(19) United States
(12) Patent Application Publication
(10) Pub. No.: US 2015/0122781 A1
(43) Pub. Date: May 7, 2015

(54) SYSTEM AND METHOD FOR SELECTING WELD PARAMETERS

(71) Applicant: ILLINOIS TOOL WORKS INC., Glenview, IL (US)

(72) Inventor: Bruce Patrick Albrecht, Neenah, WI (US)

(21) Appl. No.: 14/530,412

(22) Filed: Oct. 31, 2014

Related U.S. Application Data
(60) Provisional application No. 61/899,695, filed on Nov. 4, 2013.
(60) Provisional application No. 61/900,198, filed on Nov. 5, 2013.

(51) Int. Cl. B23K 9/10; B23K 9/095

(52) U.S. Cl. CPC B23K 9/10; B23K 9/0953; B23K 9/0956
USPC 219/73; 219/136; 219/137 R; 219/74; 219/75; 219/130.21

(57) ABSTRACT

The welder interface described above may increase synergy with the welding system for the user. The welder interface receives input parameters of a desired weld from a user and advises a weld process and weld variables for producing the desired weld. The welder interface may be integral with a component of the welding system, or a separate component that may be coupled with the welding system. The welder interface may utilize data from a look-up table, neural network, welding procedure system, or database to advise the weld process and weld variables. The user may utilize the welder interface to simulate the weld process and the effect of the weld variables on a simulated weld. The user may modify the input parameters prior to producing a weld, and the user may modify the weld variables after reviewing the results of the produced weld for subsequent welding applications.

### CROSS-REFERENCE TO RELATED APPLICATIONS

This application claims priority from and the benefit of U.S. Provisional Application Ser. No. 61/899,695, entitled “SYSTEM AND METHOD FOR SELECTING WELD PARAMETERS,” filed Nov. 4, 2013, and U.S. Provisional Application Ser. No. 61/900,198, entitled “SYSTEM AND METHOD FOR SELECTING WELD PARAMETERS,” filed Nov. 5, 2013, both of which are hereby incorporated by reference in their entireties for all purposes.

### BACKGROUND

The invention relates generally to welding systems, and more particularly, to a system for selecting parameters for a welding system.

A range of techniques have been developed for joining workpieces by welding operations. These include diverse processes and materials, with most modern processes involving arcs developed between a consumable or non-consumable electrode and the workpieces. Welding processes with non-consumable electrodes may include tungsten inert gas (TIG) welding processes, which employ a non-consumable tungsten electrode that is independent from the filler material. The processes are often grouped in such categories as constant current processes, constant voltage processes, pulsed processes, and so forth. However, further divisions between these are common, particularly in processes that consume an electrode to add filler metal to the weld. The process selected is highly linked to the filler material and its form, with certain processes utilizing a particular type of electrode. For example, certain types of metal inert gas (MIG) welding processes, which form part of a larger group sometimes referred to as gas metal arc welding (GMAW).

In GMAW welding, an electrode in the form of a wire is consumed by the progressing weld pool, melted by the heat of an arc between the electrode wire and the workpiece. The wire is continuously fed from a spool through welding torch where a charge is imparted to the wire to create the arc. The electrode configurations used in these processes are often referred to as either solid wire, flux cored or metal cored. Each type is considered to have distinct advantages and disadvantages over the others, and careful adjustments to the welding process and weld settings may be required to optimize their performance. For example, solid wire, while less expensive than the other types, is typically used with inert shielding gases, which can be relatively expensive. Flux cored wires may not require separate shielding gas feeds, but are more expensive than solid wires. Metal cored wires do require shielding gas, but these may be adjusted to mixes that are sometimes less expensive than those required for solid wires. Shielded metal arc welding (SMAW) utilizes an electrode coated or filled with one or more compounds that produce shielding gas when the arc is struck. The properties and the cost of a weld application may be based on the welding process and weld settings utilized. Unfortunately, user selection of the welding process and the weld settings for a particular application may be complex.

### BRIEF DESCRIPTION

The welder interface described may increase synergy with the welding system for the user. The welder interface receives input parameters (e.g., physical characteristics) of a desired weld from a user and advises a weld process and weld variables (e.g., electrical parameters) for producing the desired weld. The welder interface may be integral with a component (e.g., power source, wire feeder, torch) of the welding system, or a separate component that may be coupled (e.g., wired or wireless connection) with the welding system. The welder interface may utilize data from a look-up table, neural network, welding procedure system, database, or any combination thereof to advise the weld process and weld variables. The user may utilize the welder interface to simulate the weld process and the effect of the weld variables on a simulated weld. The user may modify the input parameters and/or the weld variables prior to producing a weld, and the user may modify the weld variables after reviewing the results of the produced weld to refine the advised weld process and weld variables for subsequent welding applications.

### DRAWINGS

These and other features, aspects, and advantages of the present invention will become better understood when the following detailed description is read with reference to the accompanying drawings in which like characters represent like parts throughout the drawings, wherein:

FIG. 1 is an embodiment of a welding system and a welder interface in accordance with embodiments of the present disclosure;

FIG. 2 is an embodiment of the welder interface of the welding system, in accordance with embodiments of the present disclosure;

FIG. 3 is a diagrammatical view representing movement of an embodiment of an electrode relative to a workpiece of the welding system; and

FIG. 4 is an embodiment of a method for utilizing the welder interface with the welding system, in accordance with embodiments of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the welding system as described herein may include a welder interface that receives input parameters (e.g., physical characteristics, weld parameters) and determines one or more welding processes and welding variables for implementing the one or more welding processes based at least in part on the received input parameters. The welder interface may be incorporated with or separate from a welding machine, an automation system, a power source, a wire feeder, a torch, a pendant, a networked device connected (e.g., wired or wirelessly) to the welding system, or any combination thereof. The welder interface may receive the weld parameters directly from a user, and/or the welder interface may determine the weld parameters from data (e.g., computer-aided design file) imported to the welder interface. The welder interface may determine the weld process and the weld parameters based on a variety of factors including, but not limited to, desired characteristics (e.g., quality, appearance, strength) of the welding application, user productivity, capital costs, operating costs, or consumable inventory, or any combination thereof.

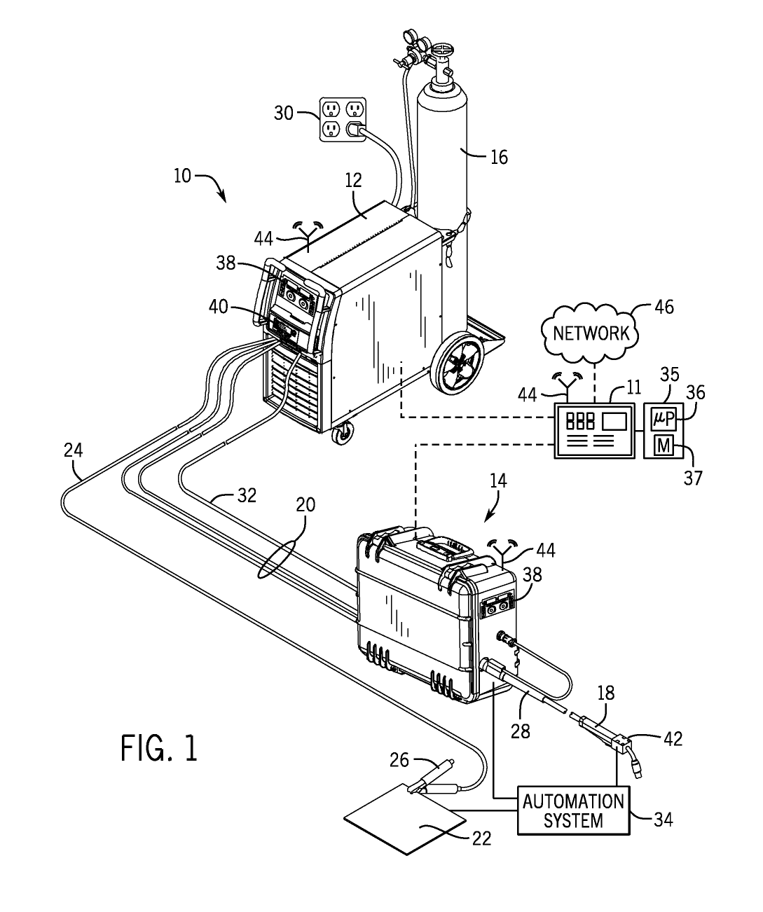

Turning to the figures, FIG. 1 is a diagram of an embodiment of a welding system 10 and a welder interface 11, in accordance with embodiments of the present disclosure. It should be appreciated that, while the welding system 10 described herein is specifically presented as a gas metal arc welding (GMAW) system 10, the welder interface 11 may also be used with other arc welding processes (e.g., FCAW, FCAW-G, GTAW (TIG), SAW, SMAW) or other welding processes (e.g., friction stir, laser, hybrid). In some embodiments, the weld interface 11 may be utilized to facilitate combining weld processes and energy sources into hybrid-type processes, where an arc welding process is combined with an energy source, such as a laser, induction heating device, plasma, and so forth. More specifically, as described in greater detail below, the equipment and accessories used in the welding system 10 may include the welder interface 11 described herein. The welding system 10 includes a welding power supply unit 12 (i.e., a welding power source), a welding wire feeder 14, a gas supply system 16, and a welding torch 18. The welding power supply unit 12 generally supplies power to the welding system 10 and other various accessories, and may be coupled to the welding wire feeder 14 via a weld cable 20 as well as coupled to a workpiece 22 using a lead cable 24 having a clamp 26. In the illustrated embodiment, the welding wire feeder 14 is coupled to the welding torch 18 via a weld cable 28 in order to supply welding wire and power to the welding torch 18 during operation of the welding system 10. In another embodiment, the welding power supply unit 12 may couple and directly supply power to the welding torch 18.

In the embodiment illustrated in FIG. 1, the welding power supply unit 12 may generally include power conversion circuitry that receives input power from an alternating current power source 30 (e.g., the AC power grid, an engine/generator set, or a combination thereof), conditions the input power, and provides DC or AC output power via the weld cable 20. As such, the welding power supply unit 12 may power the welding wire feeder 14 that, in turn, powers the welding torch 18, in accordance with demands of the welding system 10. The lead cable 24 terminating in the clamp 26 couples the welding power supply unit 12 to the workpiece 22 to close the circuit between the welding power supply unit 12, the workpiece 22, and the welding torch 18. The welding power supply unit 12 may include circuit elements (e.g., transformers, rectifiers, switches, and so forth) capable of converting the AC input power to a direct current electrode positive (DCEP) output, direct current electrode negative (DCEN) output, variable polarity, or a variable balance (e.g., balanced or unbalanced) AC output, as dictated by the demands of the welding system 10 (e.g., based on the type of welding process performed by the welding system 10, and so forth).

The illustrated welding system 10 includes a gas supply system 16 that supplies a shielding gas or shielding gas mixtures to the welding torch 18. In the depicted embodiment, the gas supply system 16 is directly coupled to the welding torch 18 via a gas conduit 32 that is part of the weld cable 20 from the welding power supply unit 12. In another embodiment, the gas supply system 16 may instead be coupled to the welding wire feeder 14, and the welding wire feeder 14 may regulate the flow of gas from the gas supply system 16 to the welding torch 18. A shielding gas, as used herein, may refer to any gas or mixture of gases that may be provided to the arc and/or weld pool in order to provide a particular local atmosphere (e.g., shield the arc, improve arc stability, limit the formation of metal oxides, improve wetting of the metal surfaces, alter the chemistry of the weld deposit, and so forth).

In addition, in certain embodiments, an automation system 34 may be used in the welding system 10. The automation system 34 may include controllers and actuators to automatically control at least a portion of the welding system 10 without additional user input. In some embodiments, the automation system 34 is connected to the power source 12, the wire feeder 14, the torch 18, or the workpiece 22, or any combination thereof. The automation system 34 may be a robotic welding system that may control the relative movement between the torch 18 and the workpiece 22 according to instructions loaded to the automation system 34. In some embodiments, the automation system 34 may control the power source 12 and/or the wire feeder 14 to control the weld process and the weld variables for a desired welding application. As discussed below, the automation system 34 may control the power source 12 and/or the wire feeder 14 based at least in part on the weld process and the weld variables determined by the welder interface 11 for the desired welding application.

The welder interface 11 includes a controller 35 to facilitate processing information related to the welding system 10. As discussed below, the user may provide input to the welder interface 11, and the welder interface determines the weld process and/or the weld variables for a welding application based at least in part on the provided input. The controller 35 utilizes a processor 36 to execute instructions loaded to the welder interface 11 and/or stored into a memory 37 to determine the weld process and/or the weld variables. In some embodiments, the welder interface 11 is incorporated with a wire feeder control panel 38, a power source control panel 40, a torch control panel 42, or any combination thereof, as illustrated by the dashed lines. Additionally, or in the alternative, the welder interface 11 may be a pendant along the weld cable 20, 28 or lead cable 24. In some embodiments, the welder interface 11 may be separate from the power source 12, the wire feeder 14, and the torch 18. For example, the welder interface 11 may include, but is not limited to, a computer, a laptop, a tablet, or a mobile device (e.g., cellular phone), or any combination thereof. The welder interface 11 may be connected to components of the welding system 10 through a wired connection or a wireless connection (e.g., via antennae 44). The connection with components of the welding system 10 may provide system information including, but not limited to, a type of power source, type of torch, or a type of wire feeder, or any combination thereof. The system information may be utilized to define processes available for the user and valid ranges for weld variables available for the user. In some embodiments, the welder interface 11 may connect with a network 46. The welder interface 11 may receive network input, such as managerial systems, welding system presets, and user preferences. In some embodiments, the input received by the welder interface 11 from the network 46 may include, but is not limited to, welding procedure specifications (WPS), procedure qualification records (PQR), test files, preferred vendor lists, preferred weld systems, a sensed welding system, part numbers, direct costs data, indirect cost data, preferred process information (e.g., MIG vs. TIG), CAD files, look-up tables, neural network data, user profiles. The welder interface 11 may transmit network output (e.g., operating history, user profiles, modified models) to the network 46. The network 46 may include, but is not limited to, a local network, a fleet network, an Internet-based resource (e.g., web page), or a cloud-based resource, or any combination thereof. As may be appreciated, the welder interface 11 may utilize information from the network 46, the welding system 10, and/or the user to establish presets and/or preferences for particular weld processes or weld variables. For example, a user may enter a preferred gas mixture and/or wire type to the welder interface 11, and the welder interface will advise the weld process and weld variables based at least in part on these preferences. Additionally, or in the alternative, the user may configure the welder interface 11 to restrict advised weld processes to one of an automated MIG process, an automated TIG process, or a manual MIG process. Moreover, a user may input a hybrid process, as discussed above, as a preferred process. Hybrid processes may enable the user to utilize the welding system to overcome limitations of a particular process through modeling the behavior of the particular process for the user for better understanding of the particular process and/or combining additional processes to overcome the limitations. For example, a friction stir process alone may be less suitable for a steel workpiece; however, the welder interface 11 may advise combining induction heating or a laser process with the friction stir process to allow the workpiece to plasticize, thereby increasing the suitability of the friction stir process. Additionally, or in the alternative, filler material may be added into the stir of the friction stir process to fill into the joint or to decrease the resistance on the stir rotation.

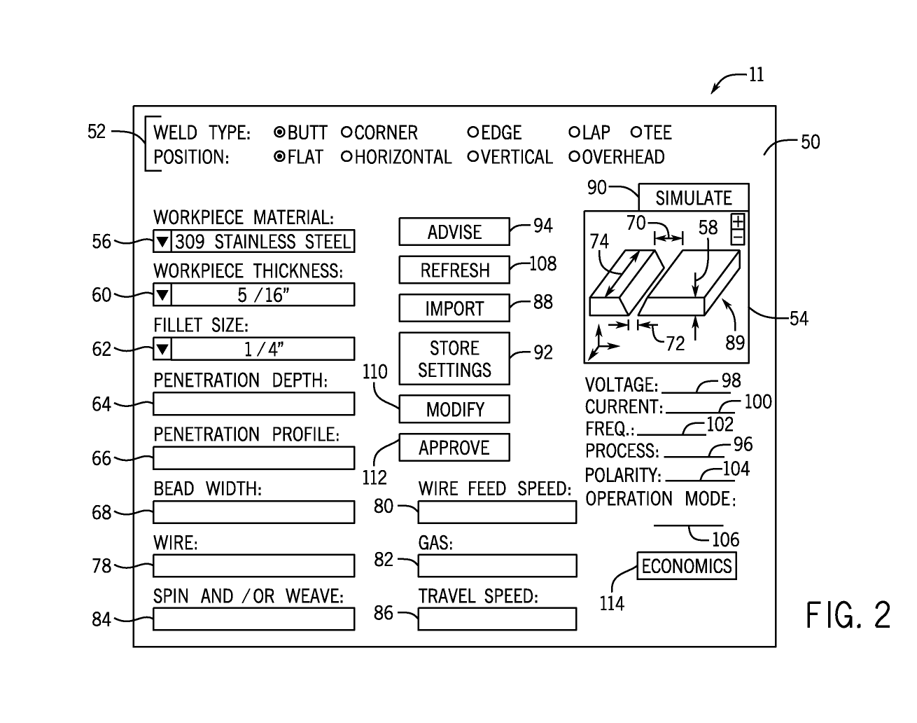

FIG. 2 illustrates an embodiment of a graphical user interface (GUI) 50 of the welder interface 11. In some embodiments, the GUI 50 is displayed on a touch screen, thereby enabling the user to manually input information directly to the welder interface 11. Additionally, or in the alternative, the GUI 50 may be utilized with accessories coupled to the welder interface 11, such as buttons, dials, knobs, switches, etc. The GUI 50 enables the user to specify input parameters (e.g., physical characteristics) for a weld which the user will be making or reviewing. The input parameters may include, but are not limited to, weld joint configurations, weld position, welding materials, and weld bead parameters. As discussed below, the welder interface 11 may advise a weld process and corresponding weld variables based at least in part on physical characteristics for the weld with or without specifying electrical parameters (e.g., voltage, current, polarity, pulse duration), thereby simplifying the set-up and preparation of the welding system 10 prior to performing the weld. The welder interface 11 may advise a weld process with no welding variables specified as input characteristics, only some (e.g., 1, 2, 3, 4, 5, 6, 7, 8, 9, 10, or more) welding variables specified as input characteristics, or substantially all of the relevant weld variables specified as input characteristics. In some embodiments, the welder interface 11 may improve the quality and/or the repeatability of a weld regardless of the experience level of the user. Based on the input parameters, the controller 35 of the welder interface 11 determines the weld process and weld variables (e.g., electrical parameters) which may be used to set the power source 12, the wire feeder 14, and/or the torch 18 to perform the desired welding application. In some embodiments, the processor 36 executing the GUI 50 may automatically set the weld process and weld variables in the power source 12, the wire feeder 14, and/or the torch 18. Alternatively, the GUI 50 may display the determined weld process and weld variables to the user for approval or modification prior to setting the power source 12, the wire feeder 14, and/or the torch 18.

GUI 50 is shown having a weld type and position selection menu 52. For example, the user may specify a butt joint, a corner joint, an edge joint, a lap joint, a tee joint, or other weld joint type. Additionally or in the alternative, the user may specify a flat position, a horizontal position, a vertical position, or an overhead position. In some embodiments, weld type and position selection menu 52 of the GUI 50 has radio buttons to specify the type and position, though it is appreciated that other conventions such as check boxes, drop-down boxes, or tabs may be used equivalently. When a user selects a weld type and/or position option, such as a butt joint and flat position, a weld depiction window 54 of the GUI 50 may display a generalized or simulated view of the type and position of joint which has been selected.

The user may specify the type of workpiece material(s) via a drop down menu 56. Thus, the GUI 50 may be programmed to present a list of material types, such as various alloys, grades, and types of metals. In certain embodiments, the GUI 50 may be pre-programmed to present only common or user-preferred material types. The GUI 50 may be further programmed to automatically set default selections for each weld type or position. As an example, FIG. 2 illustrates the selection of a 309 Stainless Steel workpiece material. Similarly, the GUI 50 permits the user to select a thickness of the workpiece(s). For example, the GUI 50 may display in a drop down menu 58, a number of preferred or common material thickness options for the material type selected in the drop down menu 56. When the operator selects a workpiece material and thickness, the weld depiction window 54 of the joint can be automatically updated to reflect the chosen characteristics.

The GUI 50 may include boxes to enable the user to describe other characteristics of the joint and/or the weld itself. For example, the user may enter values for input parameters including, but not limited to, a desired fillet size 62, a desired penetration depth 64, a penetration profile 66, a bead width 68, a bevel width 70, a gap width 72, a joint length 74, a bevel angle, or any combination thereof. In some embodiments, the user may manually enter the desired characteristics, rather than selecting them from menus. It may be appreciated, however, that other GUI conventions, such as menus and checkboxes may be used for inputting characteristics, or a click-and-drag type scalable control could be included in the GUI for increasing/decreasing a parameter value, such as the bead width 68. The specified characteristics may be shown in the weld depiction window 54, and the weld depiction window 54 may be modified as the characteristic values are adjusted. As may be appreciated, the user may readily determine the physical characteristics from a brief observation of the joint or a joint specification in a manual, whereas the determination of the weld process type and the weld variables (e.g., electrical parameters) for a weld application may be a more complex process. That is, the user may understand the physical characteristics of joint for the weld application regardless of the welding experience level of the user, whereas the understanding of the desired process and the weld variables for the desired weld application may increase with user experience. In embodiments for which the welder interface 11 may specify a GMAW welding process, the GUI 50 may also present inputs for wire type 78, wire feed speed 80, shielding gas type 82, spin or weave pattern 84, or travel speed 86, or any combination thereof. The user may leave one or more of the input parameters blank (e.g., no input parameter value), and the welder interface 11 may determine an advised value or range of values.

In some embodiments, the user may import preset joint characteristics and/or electrical parameters for a desired weld by selecting an import button 88. The import button 88 may enable the user to retrieve previously saved sets of joint characteristics from local memory storage (e.g., memory 37), or to input joint characteristics from an outside data source (e.g., network 46). For example, the joint characteristics may be uploaded directly from a CAD file or other architectural or engineering specification, a laptop computer, a mobile device, or a computer network. In other words, the welder interface 11 may download or receive data from a schematic specification file from a computing-type device and use such data to determine the joint characteristics and/or electrical parameters. The weld depiction window 54 may present a model 89 of the imported data (e.g., CAD file). In some embodiments, the GUI 50 may enable the user to modify the imported data. Additionally, or in the alternative, the user may control the weld depiction window 54 to change the model 89 of the imported data. In some embodiments, a simulate button 90 may enable the GUI 50 to display a simulation of the weld formation and/or the completed weld. The user may utilize the GUI 50 to manipulate the view and/or playback of the simulation. As may be appreciated, the simulation enables the user to preview an advised weld process, which may aid the user in performing the weld process. Additionally, or in the alternative, the user may modify the weld process and/or the weld variables upon observation of the simulation in order to change the result of the weld process from the simulated result. The user may utilize the simulations to review potential tradeoffs between related weld variables. For example, increasing the travel speed may decrease penetration and/or narrow the weld bead profile, whereas decreasing the travel speed may increase the penetration and/or widen the weld bead profile. Moreover, increasing a size of a spin and/or weave pattern may widen the weld bead profile and/or decrease penetration, and decreasing the size of a spin and/or weave pattern may narrow the weld bead profile and/or increase penetration. In some embodiments, a store settings button 92 may be used to create stored sets of characteristics (e.g., physical, electrical) from the current settings displayed by the GUI 50. These sets of characteristics may be stored in memory 37 and/or on the network 46, and may be retrieved for later use via the import button 88.

The GUI 50 includes command buttons to process the one or more user specified input parameters. The user may select an advise button 94 to control the welder interface 11 to determine one or more weld processes and weld variables to facilitate formation of the desired weld based at least in part on the specified input parameters. The GUI 50 will display the one or more weld processes and weld variables (e.g., electrical parameters) by which to set the power source 12, the wire feeder 14, and/or the torch 18. These weld variables may include, but are not limited to, a weld process 96, a power source voltage setting 98, a power source current setting 100, a power source frequency 102, a polarity 104, and an operation mode 106 (e.g., constant current CC, constant voltage CV, or pulse). The weld process 96 may include, but is not limited to, FCAW, FCAW-G, GTAW (TIG), SAW, SMAW, friction stir, laser, hybrid, or any combination thereof. In some embodiments, the weld variables determined by the welder interface 11 may include wire parameters (e.g., wire type 78, wire diameter, wire feed speed 80, quantity of wires), torch parameters (e.g., quantity of passes, weave width, spin and/or weave pattern 84, longitudinal torch travel speed 86, electrode spin speed, electrode extension speed, electrode retraction speed, travel angle, work angle), gas type 82, current changes over time (e.g., current ramp rates), voltage changes over time (e.g., voltage ramp rates), joules, pulse duration, induction heating temperature, or added laser energy, or any combination thereof. As discussed below, the welder interface 11 may utilize information from managerial preferences, user preferences, or other preferences, to determine the advised weld process and the weld variables. In some embodiments, the welder interface 11 may utilize information (e.g., reference data) from a welding procedure specification (WPS), a look-up table, a network database, or a neural network, or any combination thereof, to determine the advised weld process and the weld variables.

As may be appreciated, upon selection of the advise button 94, the welder interface 11 may determine any of the input parameters left blank (e.g., no input value provided). The GUI 50 may also enable the user to alter previously-selected input parameters (e.g., physical characteristics) and have the GUI 50 re-determine the weld process and the weld variables by selection of a refresh button 108. In some embodiments, the one or more weld processes and the weld variables determined by the welder interface 11 for the user may be displayed on one or more screens to be reviewed by the user. Upon review of the advised weld process and corresponding weld variables, the user may modify the advised determinations via selection of a modify button 110. For example, the user may modify one or more weld variables (e.g., wire feed speed 80, voltage 98, frequency 102) while maintaining at least some of the advised weld variables or input parameters. After modification (if any) of the weld variables or input parameters, the user may approve of the weld process and the weld variables via selection of an approve button 112, thereby enabling the welder interface 11 to control the power source 12, the wire feeder, and/or the torch 18 to perform the weld application with the advised weld process and the advised weld variables.

In some embodiments, an economics button 114 enables the user to review various economic factors for the advised weld process and weld variables. The cost of performing a welding application may be based at least in part on the cost of consumables (e.g., welding wire, contact tip, shielding gas, electrode), energy costs, labor costs, facility costs, equipment costs. For example, forming a weld for a deep groove application with relatively large wire diameter welding wire may have lower labor costs than forming the weld in the deep groove application with a relatively small wire diameter welding wire because of an increased number of passes to form the weld. Additionally, a flux cored or metal cored electrode may have a greater consumable cost than a solid electrode for some applications; however, the labor cost and/or shielding gas cost may be less for the flux cored or metal cored electrode than a solid electrode for other applications. Moreover, some weld processes (e.g., TIG processes, advanced weld processes, hybrid weld processes) may be associated with higher labor costs than other weld processes (e.g., SMAW processes, MIG processes), where higher labor costs may be based at least in part on greater operator skill level. Facility costs may include, but are not limited to, costs associated with maintenance and supply costs for the automation system 34 that may execute the weld process. Equipment costs may include, but are not limited to, costs associated with procurement of components of the welding system 10. User selection of the economics button 114 may display data that provides approximate costs for weld processes that may be utilized for the desired welding application. Accordingly, the welder interface 11 may advise a weld process and weld variables based at least in part on economic factors, such as cost.

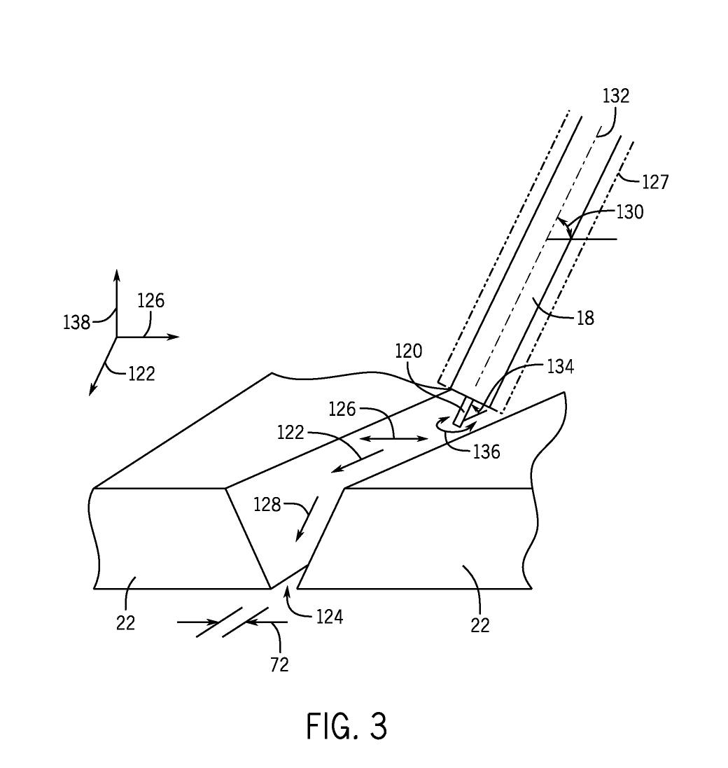

FIG. 3 illustrates an embodiment of movement of the torch 18 and an electrode 120 relative to the workpiece 22. The welder interface 11 may determine weld variables that may include variables that describe movement of the torch 18 and/or an electrode 120 relative to the workpiece 22. FIG. 3 illustrates some of the weld variables that describe the arrangement of the torch 18, the electrode 120, and the workpiece 22 relative to one another during a weld. The torch 18 and the electrode 120 move in a longitudinal travel direction 122 along a joint 124 between the workpiece materials 22. As the electrode 120 moves along the joint 124, the weld is formed as portions of the electrode 120 are deposited onto the workpiece 22 and/or onto previously deposited electrode material (e.g., weld pool). The electrode 120 may move in a transverse direction 126 and/or an axial direction 128 relative to the joint 124. The movement of the torch 18 and the electrode 120 in the transverse direction 126 may be defined herein as a weave pattern. The dashed lines 127 illustrate an embodiment of the movement (e.g., oscillation) of the torch 18 within the weave pattern across the joint 124. A work angle 130 describes the angle between an axis 132 of the electrode 120 and the joint 124 along the transverse direction 126. A torch angle 134 describes the angle between the axis 132 of the electrode and the joint 124 along the longitudinal direction 122.

In some embodiments, the electrode 120 may be moved (e.g., spun) in a desired pattern relative to the torch 18 while the torch 18 moves in the longitudinal travel direction 122. The electrode 120 may spin within the joint 124, as shown by arrow 136, thereby increasing the area in which the electrode material may be deposited within the joint 124. The electrode 120 may be moved in a variety of patterns including, but not limited to, a circle, an ellipse, a zigzag, a FIG. 8, a transverse reciprocating line, a crescent, a “C” shape, a “J” shape, a “T” shape, a triangle, a square, a rectangle, a non-linear pattern, an asymmetrical pattern, a pause, or any combination thereof. Such movement patterns and applications of the movement patterns are described in U.S. Provisional Patent Application No. 61/878,404, entitled “Synchronized Rotating Arc Welding Method and System,” filed by Christopher Hsu et al. on Sep. 16, 2013, which is hereby incorporated into the present disclosure by reference.

The torch 18 and/or the electrode 120 may be moved along the axis 132 to control the deposition of the electrode material into the joint 124. In some embodiments, user may utilize multiple passes of the torch 18 and the electrode 120 along the joint 124, with each pass forming a layer such that the completed weld has multiple layers in a vertical direction 138. Additionally, or in the alternative, the weld process may control the movement (e.g., extension, retraction) of the electrode 120 along the axis 132 relative to the torch 18. For example, the electrode 120 movement along the axis 132 may be controlled to affect the deposition rate of the electrode material and/or the heat applied to the workpiece. In some embodiments, the movement of the electrode 120 along the axis 132 may be controlled with the desired movement pattern (e.g., arrow 136) to control the deposition location of the electrode material.

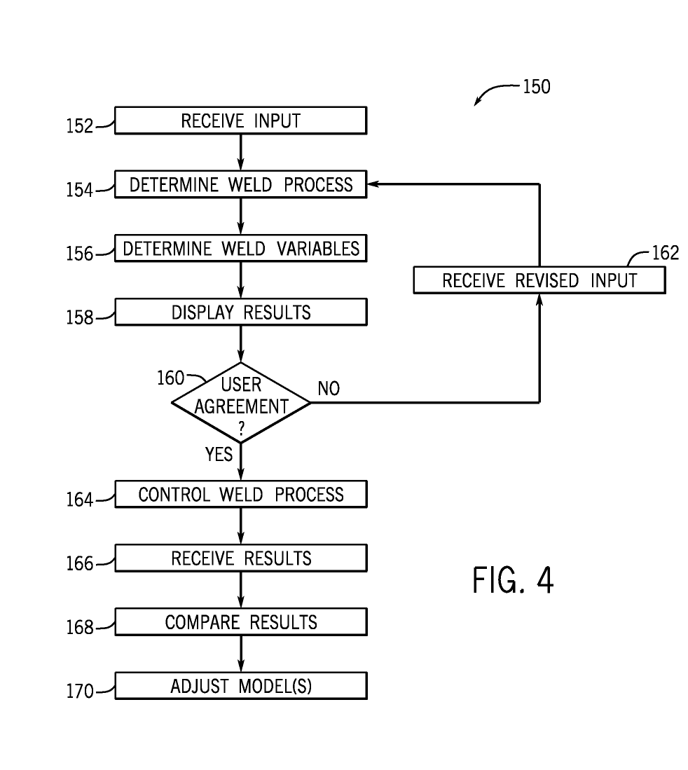

FIG. 4 illustrates an embodiment of a method 150 for utilizing the welder interface 11 for determination of a weld process and weld variables. The welder interface 11 receives (block 152) input parameters (e.g., physical characteristics) from the user. The input parameters may be received via manual input through the GUI 50 and/or automatically via importation of data (e.g., CAD file) as described above. Based at least in part on the received input parameters, the welder interface 11 determines (block 154) at least one weld process and determines (block 156) weld variables for the at least one weld process. The welder interface 11 then displays (block 158) the results of the determined one or more weld processed and the weld variables to the user for review and approval. In some embodiments, the results may be displayed via a simulation of the weld process and/or the completed weld.

The welder interface 11 utilizes the received input parameters and determines the weld process (block 154) and the weld variables (block 156) utilizing data stored in the memory 37 and/or the network 46. The data stored in the memory 37 and/or the network 46 may relate various factors associated with weld processes and weld variables. For example, the determination of a particular weld process and the weld variables for the weld process may be based at least in part on the applicability (e.g., economics, quality, strength, appearance) of the weld process for various physical characteristics of the desired weld. The applicability of the determined weld process may include, but is not limited to, the economics (e.g., costs) of the determined weld process and weld variables, the user skill level, complexity of the determined weld process, welding systems available to the user, inventory available to the user, and user productivity/efficiency. The data stored in the memory 37 and/or the network 46 may be in the form of a look-up table, a neural network, a network database, managerial system, presets, and preferences to include a welding procedure specification (WPS), or any combination thereof. In some embodiments, the manufacturer and/or the user may populate data sets to be loaded into the memory 37 and/or the network 46 for a variety of weld processes. For example, TIG welding may be advised for a welding application with relatively thin workpiece materials and/or with aluminum alloys, and MIG welding may be advised for a welding application with relatively thick workpiece materials and/or for open root applications. In some embodiments, a friction stir and/or a hybrid process may be advised for a relatively flat bead profile and/or to increase heating to the workpiece 22.

Upon display (block 158) of the advised weld process and the weld variables, the user decides (node 160) whether to accept the advised weld process and weld variables or to revise (block 162) the input provided to the welder interface to potentially generate a different advised weld process and weld variables. In some embodiments, the user may revise the input parameters (e.g., physical characteristics) provided to the welder interface 11. Additionally, or in the alternative, the user may add or remove input parameters (e.g., physical characteristics, electrical parameters) provided to the welder interface 11. As may be appreciated, the display (block 158) of the advised weld process and the weld variables may include the welder interface 11 simulating the advised weld process. The welder interface 11 may display the simulation at various speeds (e.g., real time, slow motion) and various views or orientations (e.g., 2D, 3D). Moreover, the welder interface 11 may display a simulation of the dynamics of the simulated weld from different perspectives, such as a close view illustrating the dynamics of the electrode and weld pool, or a component view (e.g., cross-sectional view) illustrating the effect on the joint and/or workpiece as a whole. The simulations displayed by the welder interface 11 may include, but are not limited to, simulated wire placement in the joint or weld pool, visual wire feed speed changes, graphs of predicted (e.g., simulated) current and voltage, puddle agitation, spatter levels, other effects, or any combination thereof.

When the user agrees to the advised weld process and the weld variables, the welder interface 11 may control (block 164) the components (e.g., power source 12, wire feeder 14, torch 18) of the welding system 10 to enable the user and/or the automation system 34 to perform the desired welding application. For example, the welder interface 11 may control the wire feeder 14 with the advised wire feed speed for an advised MIG welding process, and the welder interface 11 may set the voltage, current, and pulse parameters of the power source 12 for the advised MIG welding process. Upon completion of the weld, the user and/or the welder interface 11 may review the weld and generate results (e.g., scores) regarding observable qualities of the weld. For example, the user may review aspects of the appearance of the weld, such as bead width, bead spacing, penetration, burn through, porosity, cracks, and so forth. Additionally, or in the alternative, the user or the welder interface 11 may review aspects of the weld history, such as the voltage waveform, the current waveform, or filler metal (e.g., welding wire) utilized. The welder interface 11 may receive (block 166) results from the user to facilitate comparing (block 168) the results of the actual weld to prior results and/or to simulated results. Based at least in part on the comparison, the welder interface 11 may adjust (block 170) models in the memory 37 and/or on the network 46 that were utilized to advise the weld process and the weld variables.

In some embodiments, the method 150 described above may be utilized iteratively to populate data (e.g., models) for a look-up table, database, or neural network. For example, the user may initially only input the physical characteristics as input parameters, and the user may subsequently revise the input parameters to specify a particular weld process (e.g., TIG, MIG, SMAW) or a set of one or more electrical parameters (e.g., voltage, current, frequency, polarity, wire feed speed) to change properties of the resulting weld. The user may utilize the method 150 to determine the effect of adjusting one or more weld variables (e.g., electrical parameters), while maintaining or managing some level of change to the weld process and physical characteristics. This enables the user to modify the data to approximate variations that may occur during actual weld formation that may not be otherwise accounted for during a simulation of the weld. As another example, the user may modify the weld variables for the spin and/or weave patterns alone or in combination with the voltage, current, wire feed speed, and travel speed to control the deposition location of the electrode material to the weld. Additionally, or in the alternative, the weld current may be modified to control spray and/or spatter of electrode material, the weld voltage may be modified to control penetration, or travel speed may be modified to control the fluidity of the weld pool. In some embodiments, iterative modification of the weld variables utilizing the welder interface 11 enables the user to generate robust models that may be utilized to advise a weld process and weld variables with relatively complex timing, speed, and energy levels to generate a desired weld even when the user provides relatively simple input parameters (e.g., physical characteristics).

The welder interface 11 may recommend the weld variables based on user preferences incorporated into the models. In some embodiments, the welder interface 11 may enable the welding system 10 to control the penetration depth to reduce or eliminate burn through of the workpiece 22. As may be appreciated, AC processes may be utilized to manage deposition and/or burn through. The welder interface 11 may advise a particular polarity to be utilized at certain points within the joint. For example, positive polarity when weaving the torch 18 over a seam may increase penetration, and negative polarity when weaving the torch 18 over the sidewalls of the joint may enable the workpiece materials to cool more than under a positive polarity. Additionally, or in the alternative, the welder interface 11 may advise one or more pauses to alter the penetration in conjunction with the wire feed speed to adjust the penetration depth of the weld. In some embodiments, welder interface 11 may advise a combination of one or more weld processes (e.g., controlled short circuit process in a first portion, an AC process in a second portion, and a pulse process in a third portion) to manage the penetration of a weld into the joint. The welder interface 11 may utilize feedback (e.g., sensor feedback) from the welding system 10 to modify the weld process and/or the weld variables in substantially real-time. For example, the welder interface 11 may utilize position and/or motion feedback of the torch 18 and the electrode 120 relative to the workpiece 22 to control the timing of adjustments to weld variables.

In some embodiments, the models stored in memory 37 and/or the network 46 may be based at least in part on a volumetric calculation of deposited filler material, thermal dynamics of the welding application, and/or fluid dynamics of the molten filler material. For example, the welder interface 11 may advise a weld process with a deposition rate, travel speed, and wire feed speed that would deposit a volume of filler material (e.g., welding wire) that would fill the joint with a desired density/porosity. The welder interface 11 may be configured to advise the weld process based at least in part on forces acting on the filler material prior to solidification with the workpiece. For example, the welder interface 11 may advise the weld process based at least in part on the weld position, gravity, centrifugal forces on the molten filler material due to the conventional wire placement, weave of the torch and/or spin of the electrode, or any combination thereof.

The models utilized by the welder interface 11 may incorporate thresholds to maintain the advised weld process and the advised weld variables within desired economic bounds. For example, the welder interface 11 may be configured to advise a welding process with the lowest cost that satisfies the specifications for the desired weld. Additionally, or in the alternative, the welder interface 11 may be configured to advise welding processes that are within a range of skill levels to increase the reproducibility and the quality of the welds performed by users utilizing the welder interface 11. In some embodiments, when multiple weld processes may be capable of producing a desired weld based on the input parameters, the welder interface 11 may advise a weld process that has a lower cost and/or a lower complexity relative to other the capable weld processes.

The welder interface described above may increase synergy with the welding system for the user. The welder interface receives input parameters (e.g., physical characteristics) of a desired weld from a user and advises a weld process and weld variables (e.g., electrical parameters) for producing the desired weld. The welder interface may be integral with a component (e.g., power source, wire feeder, torch) of the welding system, or a separate component that may be coupled (e.g., wired or wireless connection) with the welding system. The welder interface may utilize data from a look-up table, neural network, welding procedure system, database, or any combination thereof to advise the weld process and weld variables. As described above, the user may utilize the welder interface to simulate the weld process and the effect of the weld variables on a simulated weld. The user may modify the input parameters and/or the weld variables prior to producing a weld, and the user may modify the weld variables after reviewing the results of the produced weld to refine the advised weld process and weld variables for subsequent welding applications. In some embodiments, the welder interface may control the weld process and the weld variables in real time to control the results to a modeled result. For example, when welding a pipe root pass, the welder interface may receive feedback from a spin torch on the location of the wire placed in the joint via an encoder, tachometer, or other sensor. The feedback to the welder interface enables the welder interface to control the welding system to modulate the wire feed speed, the spin speed, the electrical parameters, or any combination thereof, to reduce or eliminate burn through. The welder interface may sense burn through or an impending burn through via sensing the voltage, current, visual appearance of the weld, or an audible sound of the weld, or any combination thereof. The welder interface may track the movement of the wire within the joint via observation of the voltage and spin as the wire rotates within the joint. In some embodiments, the welder interface may deliver the advised weld process and weld variables in real time to one or more welding systems at a work site, thereby enabling the one or more welding systems to be utilized for the advised weld process. Moreover, the welder interface may display the voltage, current, wire feed speed, and other weld variables on graphs, charts, or oscilloscope formats, or any combination thereof.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system comprising:
a welding interface configured to determine one or more weld processes and one or more weld variables for producing a desired weld based at least in part on input parameters for the desired weld and based at least in part on economics corresponding to the one or more weld processes and the one or more weld variables, wherein the input parameters comprise one or more physical characteristics of the desired weld, and the one or more weld variables comprise electrical parameters.

2. The welding system of claim 1, wherein the input parameters comprise a weld type, a weld position, a workpiece material, a workpiece thickness, a penetration depth, a penetration profile, a desired fillet size, a bead width, a bevel width, a gap width, a joint length, or a bevel angle, or any combination thereof.

3. The welding system of claim 1, wherein the economics corresponding to the one or more weld processes and the one or more weld variables comprise consumables costs, labor costs, energy costs, facility costs, equipment costs, or any combination thereof.

4. The welding system of claim 1, wherein the electrical parameters comprise a voltage setting, a current setting, a frequency, a polarity, or an operation mode, or any combination thereof, and the one or more weld variables comprise wire parameters, torch parameters, or any combination thereof.

5. The welding system of claim 1, wherein the welding interface is configured to display simulations of the determined one or more weld processes and one or more weld variables, and the displayed simulations facilitate evaluation of the determined one or more weld processes and the one or more weld variables.

6. The welding system of claim 1, wherein the welding interface is integral with a component of the welding system, and the component comprises a power source, a wire feeder, or a torch, or any combination thereof.

7. The welding system of claim 1, wherein the welding interface is connected to a network, and the welding interface is configured to receive the input parameters for the desired weld via the network.

8. The welding system of claim 1, comprising:
a torch configured to receive weld power; and
an automation system coupled to the welding interface and to the torch, wherein the welding interface is connected to an automation system, and the automation system is configured control the torch to produce the desired weld based at least in part on the determined one or more weld processes and one or more weld variables.

9. A method comprising:
receiving one or more input parameters for a desired weld;
determining a weld process and weld variables for the determined weld process based at least in part on the one or more input parameters and reference data, wherein one or more input parameters comprise physical characteristics of the desired weld, the weld variables comprise electrical parameters of a welding system configured to produce the desired weld, and the reference data comprises a look-up table, a neural network, a database, a welding procedure specification, or any combination thereof;
determining an applicability of the determined weld process and weld variables, wherein the determined applicability comprises economics corresponding to the determined weld process and weld variables, a user skill level, or any combination thereof; and
displaying the determined weld process, weld variables for the determined weld processes, and the determined applicability of the determined weld process and weld variables.

10. The method of claim 9, wherein receiving one or more input parameters for the desired weld comprises loading a schematic specification file into a memory, and determining the one or more input parameters from the schematic specification file.

11. The method of claim 9, comprising displaying simulations of the determined weld process and weld variables.

12. The method of claim 9, comprising controlling settings of the welding system based at least in part on the determined weld process and the determined weld variables.

13. The method of claim 12, comprising:
receiving, during weld formation, feedback from the welding system, wherein the feedback comprises position feedback of a welding torch, motion feedback of the welding torch, or any combination thereof; and
modifying, during weld formation, the settings of the welding system based at least in part on the determined weld process and the received feedback.

14. The method of claim 9, wherein the determined applicability comprises complexity of the determined weld process, available welding systems, available inventory, or any combination thereof.

15. The method of claim 9, wherein the weld process comprises a gas metal arc welding (GMAW) process, a flux core arc welding (FCAW) process, tungsten inert gas (TIG) welding process, a shielded metal arc welding process (SMAW), a submerged arc welding (SAW) process, a friction stir welding process, a laser welding process, or any combination thereof.

16. The method of claim 9, comprising modifying the reference data based at least in part on user input.

17. A welding system, comprising:
a welding interface configured to control the welding system, to determine a weld process and one or more weld variables for producing a desired weld based at least in part on input parameters for the desired weld, and to display a simulation or economics corresponding to the determined weld process and the determined one or more weld variables, wherein the input parameters comprise a weld type, a weld position, a workpiece material, a workpiece thickness, a penetration depth, or a penetration profile, or any combination thereof, the one or more weld variables comprise a voltage setting, a current setting, a frequency, a polarity, or an operation mode, or any combination thereof, and the economics comprise consumables costs, labor costs, energy costs, facility costs, equipment costs, or any combination thereof.

18. The welding system of claim 17, comprising a plurality of sensors configured to provide feedback to the welding interface, wherein the welding interface is configured to control the welding system during weld formation of the desired weld based at least in part on the feedback, the determined weld process, and the determined one or more weld variables.

19. The welding system of claim 17, wherein the welding interface is configured to determine the weld process and the one or more weld variables without receiving electrical parameters.

20. The welding system of claim 17, the simulation of the determined weld process and the one or more weld variables comprises simulated views of the weld process, electrode placement relative to a workpiece, graphs of simulated weld variables, or any combination thereof.
